(19) United States
(12) Patent Application Publication
(10) Pub. No.: US 2008/0270568 A1
(43) Pub. Date: Oct. 30, 2008

(54) METHOD, PORTABLE APPARATUS AND SERVER

(75) Inventors: Jaakko LEHIKOINEN, Hameenkyro (FI); Pertti HUUSKONEN, Tampere (FI)

Correspondence Address: PERMAN & GREEN, 425 POST ROAD, FAIRFIELD, CT, 06824, US

(73) Assignee: NOKIA CORPORATION, Espoo (FI)

(21) Appl. No.: 11/740,571

(22) Filed: Apr. 26, 2007

(51) Int. Cl. G06F 15/16

(52) U.S. Cl. 709/217

(57) ABSTRACT

It is presented a method for a portable apparatus including: determining a current context; determining a remote context; receiving current data, associated with the current context of the apparatus; receiving remote data associated with the remote context; evaluating whether there is a match between the current data and the remote data; and when the current data and the remote data is considered a match, alerting the user. Corresponding apparatuses and computer program products are also presented.

### FIELD OF THE INVENTION

The disclosed embodiments generally relate to online communities and more particularly to methods and apparatuses for improved access to online communities.

### BACKGROUND OF THE INVENTION

Mobile terminals, or mobile (cellular) telephones, for mobile telecommunications systems like GSM, UMTS, D-AMPS and CDMA2000 have been used for many years now. In the older days, mobile terminals were used almost exclusively for voice communication with other mobile terminals or stationary telephones. More recently, the use of modern terminals has been broadened to include not just voice communication, but also various other services and applications such as www/wap browsing, video telephony, electronic messaging (e.g. SMS, MMS, email, instant messaging), digital image or video recording, FM radio, music playback, exercise analysis, electronic games, calendar/organizer/time planner, word processing, etc.

At the same time, many users of the mobile terminals are members of remote contexts, such as discussion forums and/or blogs. It is a problem for users to know what is being posted in the remote contexts when the user is not actively taking part in these contacts.

One known solution is to use RSS (Really Simple Syndication/Rich Site Summary/RDF Site Summary) to subscribe to new content. However, RSS subscriptions easily generate a vast amount of posts, making it difficult and not so user friendly to read all the posts on a mobile terminal.

Consequently, there is a need to provide a mobile communication terminal and method providing a user with an improved way of staying in touch with remote contexts.

### SUMMARY

According to a first aspect of the claimed invention there has been provided a method for a portable apparatus comprising: determining a current context; determining a remote context; receiving current data, associated with the current context of the apparatus; receiving remote data associated with the remote context; evaluating whether there is a match between the current data and the remote data; and when the current data and the remote data is considered a match, alerting the user.

The remote context may previously have been selected by the user.

The determining a current context may comprise determining a current location of the portable apparatus.

The determining a remote context may comprise determining an association of the user with any context selected from the group consisting of an online community, a blog, and an online forum.

The evaluating whether there is a match may comprise statistical text analysis of text of the current data and the remote data.

The evaluating whether there is a match may comprise, prior to the statistical text analysis: using at least part of the text of the current data or at least part of the remote data as candidate text; looking up the candidate text in a table; when there is a match of the candidate text in the table, reading associated text from the memory, the associated text being associated with the match with the candidate text; and adding the associated text to the current data or the remote data, according to the source of the candidate data.

The receiving current data may comprise receiving the current data over a local communication channel.

The local communication channel may be a channel selected from the group consisting of bluetooth, wireless local area network, radio frequency identification, wireless universal serial bus and any combination of the above.

The receiving current data may comprise receiving the data based on a position of the apparatus, the position being acquired by use of a global positioning system.

The receiving the remote data may comprise receiving data using a news feed and the news feed may comprise the use of RSS.

The method may be executed in the portable apparatus.

The method may be executed in a server.

A second aspect of the claimed invention is a portable apparatus comprising: a controller; the controller being configured to determining a current context; the controller being further configured to determining a remote context; the controller being further configured to receive current data, associated with a current context of a user of the apparatus; the controller being further configured to receive remote data associated with a context previously selected by the user; the controller being further configured to evaluate whether there is a match between the current data and the remote data; and the controller being further configured to alert the user when the current data and the remote data is considered a match.

A third aspect of the claimed invention is a portable apparatus comprising: means for determining a current context; means for determining a remote context; means for receiving current data, associated with a current context of the apparatus; means for receiving remote data associated with a context previously selected by the user; means for evaluating whether there is a match between the current data and the remote data; and means for alerting the user when the current data and the remote data is considered a match.

A fourth aspect of the claimed invention is a server comprising: a controller; the controller being configured to determine a current context; the controller being further configured to determining a remote context; the controller being further configured to receive current data, associated with a current context of a user a portable apparatus connected to the server; the controller being further configured to receive remote data associated with a context previously selected by the user; the controller being further configured to evaluate whether there is a match between the current data and the remote data; and the controller being further configured to alert the user when the current data and the remote data is considered a match.

A fifth aspect of the claimed invention is a computer program product comprising software instructions that, when executed in a mobile communication terminal, performs the method according to the first aspect.

Other features and advantages of the disclosed embodiments will appear from the following detailed disclosure, from the attached dependent claims as well as from the drawings.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

Embodiments will now be described in more detail, reference being made to the enclosed drawings, in which:

FIG. 1 is a schematic illustration of a cellular telecommunication system, as an example of an environment in which the aspects of the disclosed embodiments may be applied.

FIG. 2 is a schematic front view illustrating a mobile terminal according to an aspect of the disclosed embodiments.

FIG. 3 is a schematic block diagram representing an internal component, software and protocol structure of the mobile terminal shown in FIG. 2.

FIG. 4 is a flow chart illustrating a context comparison.

FIG. 5 shows a table that can be used in the process illustrated in FIG. 4.

### DETAILED DESCRIPTION OF THE INVENTION

The disclosed embodiments will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout.

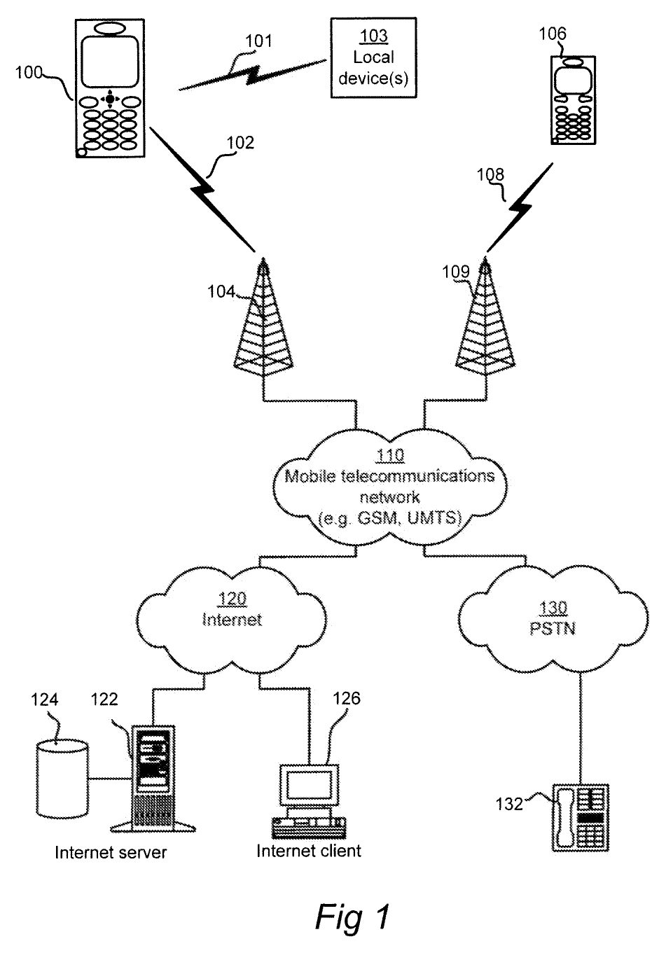

FIG. 1 illustrates an example of a cellular telecommunications system in which the invention may be applied. In the telecommunication system of FIG. 1, various telecommunications services such as cellular voice calls, www/wap browsing, cellular video calls, data calls, facsimile transmissions, music transmissions, still image transmissions, video transmissions, electronic message transmissions and electronic commerce may be performed between an apparatus being a mobile terminal (or mobile communication terminal) 100 being a portable apparatus according to the disclosed embodiments and other devices, such as another mobile terminal 106 or a stationary telephone 132. It is to be noted that for different embodiments of the mobile terminal 100 and in different situations, different ones of the telecommunications services referred to above may or may not be available; the invention is not limited to any particular set of services in this respect.

The mobile terminals 100, 106 are connected to a mobile telecommunications network 110 through RF links 102, 108 via base stations 104, 109. The mobile telecommunications network 110 may be in compliance with any commercially available mobile telecommunications standard, such as GSM, UMTS, D-AMPS, CDMA2000, FOMA and TD-SCDMA.

The mobile telecommunications network 110 is operatively connected to a wide area network 120, which may be Internet or a part thereof. An Internet server 122 has a data storage 124 and is connected to the wide area network 120, as is an Internet client computer 126. The server 122 may host a www/wap server capable of serving www/wap content to the mobile terminal 100. A connection thus exists between the mobile terminal 100 and the Internet server 122, which can for example host discussion forums or blogs.

A public switched telephone network (PSTN) 130 is connected to the mobile telecommunications network 110 in a familiar manner. Various telephone terminals, including the stationary telephone 132, are connected to the PSTN 130.

The mobile terminal 100 is also capable of communicating locally via a local link 101 to one or more local devices 103. The local link can be any type of link with a limited range, such as Bluetooth, a Universal Serial Bus (USB) link, a Wireless Universal Serial Bus (WUSB) link, an IEEE 802.11 wireless local area network (WLAN) link, an RS-232 serial link, etc. The local devices 103 can for example be various sensors that can communicate measurement values to the mobile terminal 100 over the local link 101.

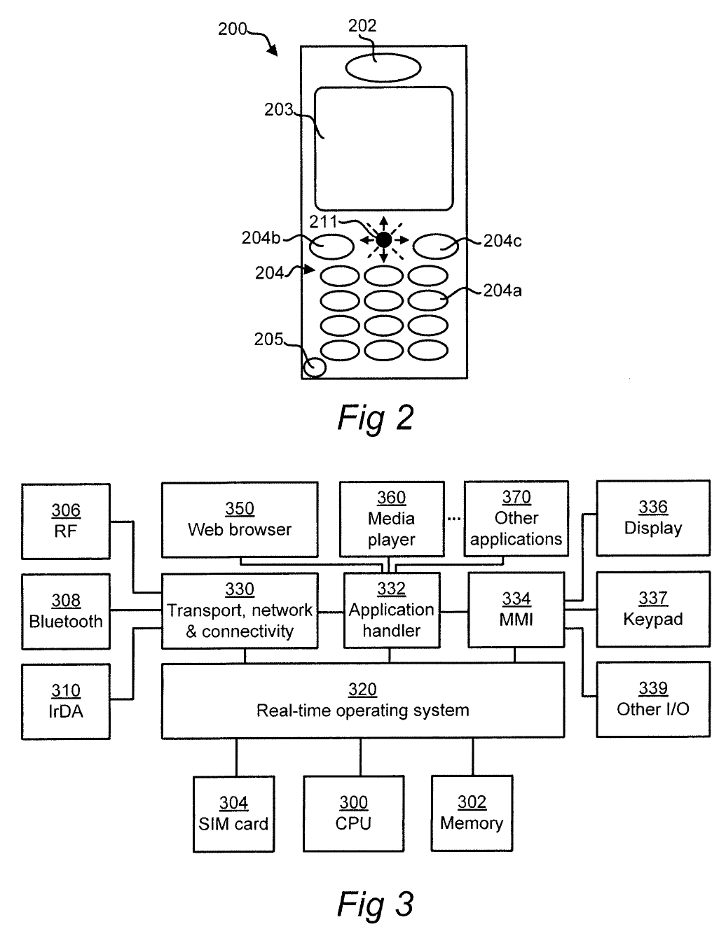

An embodiment 200 of the mobile terminal 100 is illustrated in more detail in FIG. 2. The mobile terminal 200 comprises a speaker or earphone 202, a microphone 205, a display 203 and a set of keys 204 which may include a keypad 204a of common ITU-T type (alpha-numerical keypad representing characters “0”-“9”, “*” and “#”) and certain other keys such as soft keys 204b, 204c and a joystick 211 or other type of navigational input device. The display 203 may be a regular display or a touch-sensitive display.

The internal component, software and protocol structure of the mobile terminal 200 will now be described with reference to FIG. 3. The mobile terminal has a controller 300 which is responsible for the overall operation of the mobile terminal and is preferably implemented by any commercially available CPU (“Central Processing Unit”), DSP (“Digital Signal Processor”) or any other electronic programmable logic device. The controller 300 has associated electronic memory 302 such as RAM memory, ROM memory, EEPROM memory, flash memory, or any combination thereof. The memory 302 is used for various purposes by the controller 300, one of them being for storing data and program instructions for various software in the mobile terminal. The software includes a real-time operating system 320, drivers for a man-machine interface (MMI) 334, an application handler 332 as well as various applications. The applications can include a web browser application 350, a media player application 360, as well as various other applications 370, such as applications for voice calling, video calling, sending and receiving SMS, MMS or email, an instant messaging application, a phone book application, a calendar application, a control panel application, a camera application, one or more video games, a notepad application, etc.

The MMI 334 also includes one or more hardware controllers, which together with the MMI drivers cooperate with the display 336/203, keypad 337/204 as well as various other I/O devices 339 such as microphone, speaker, vibrator, ringtone generator, LED indicator, motion sensor etc. The user may operate the mobile terminal through the man-machine interface thus formed.

The software also includes various modules, protocol stacks, drivers, etc., which are commonly designated as 330 and which provide communication services (such as transport, network and connectivity) for an RF interface 306, and optionally a Bluetooth interface 308 and/or an IrDA interface 310 for local connectivity. Additionally, communication can be configured for other communication protocols, such as wireless local area network, IEEE 802.11 (not shown) or to receive location information through for example a global positioning system (GPS) (not shown). The RF interface 306 comprises an internal or external antenna as well as appropriate radio circuitry for establishing and maintaining a wireless link to a base station (e.g. the link 102 and base station 104 in FIG. 1). As is well known to a man skilled in the art, the radio circuitry comprises a series of analogue and digital electronic components, together forming a radio receiver and transmitter. These components include, i.a., band pass filters, amplifiers, mixers, local oscillators, low pass filters, AD/DA converters, etc.

The mobile terminal also has a SIM card 304 and an associated reader. As is commonly known, the SIM card 304 comprises a processor as well as local work and data memory.

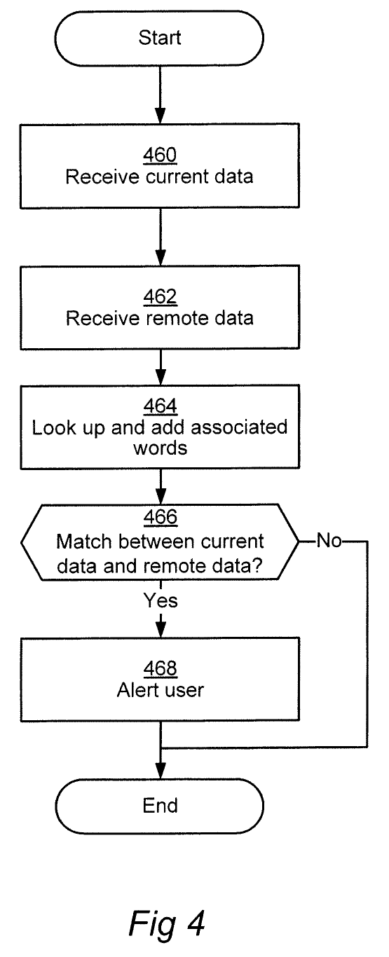

FIG. 4 is a flow chart illustrating a context comparison.

In a receive current data step 460, data representing a current context of the mobile terminal is received. This data relates to a current context of the mobile terminal, either physical or logical. As an example of a physical current context, the terminal could for example be located in an art gallery, and data relating to this location is made available to the mobile terminal. The data can for example be transferred by wireless local connectivity, such as bluetooth, wireless local area network, radio frequency identification, wireless universal serial bus or any combination of these; by local wire-based connectivity such as universal serial bus, firewire IEEE 1394, or an RS232 serial connection. The current data could here be information relating to the art gallery and/or the current exhibition in the art gallery.

Another way to receive current data is by using information about the location of the mobile terminal, e.g. using global positioning system (GPS). The location can then be translated to one or more location names of e.g. street, city, county, state, country, etc.

As an example of a logical current context, a user may be visiting web sites for various art galleries with different profiles. The current data is here data on the currently visited web site.

In a receive remote data step 462, data related to remote data is received in the mobile terminal. Optionally, the user has previously selected the remote context. For example, the remote context can be an online discussion forum that the user is a member of, a blog that the user visits and regularly posts comments to, or any other online community. The remote data is received in the mobile terminal over the wide area network 120. One suitable transfer mechanism is RSS (Really Simple Syndication/Rich Site Summary/RDF Site Summary), whereby the mobile terminal is made aware of new posts that have been made available on the remote context. Other suitable transfer mechanisms can equally well be used.

In the look up and add associated words step 464, text from data relating to the current context is analyzed. Within the mobile terminal there is a table in the memory 302 (FIG. 3) containing words being associated words. For example, a link to the web site foo may indicate that the text is related to a movie, if foo is a web site containing a lot of information about movies. After a check in the table, the link to foo corresponds to a text “(movie, film)”. The text “(movie, film)” is therefore inserted in the text after the link to foo. Consequently, if the original text was “I went to see Casablanca foo” where foo denotes a link to foo, the modified text reads “I went to see Casablanca foo(movie, film)”. The following text comparison (see below) will then make a more accurate match. The table matching can allow wildcards. The table can thereby have entries matching place names with typical activities. For example, there may be an entry where Val d'Isère has the text “(skiing)” associated with it. Alternatively or additionally, this text analysis can be performed on text from data relating to the remote context.

In a conditional match between current data and remote data step 466, the previously processed current context data and remote context data are analyzed whether to evaluate whether there is a statistical match between the two texts. The threshold for such a match can be fixed or configurable by the user. If there is no match, the process ends. Otherwise, if there is a match between the current context data and remote context data, the process proceeds to an alert user step 468.

In the alert user step 468, the user is alerted to the fact that there is a match between the current context and a remote context.

For purposes of illustration, it will now be presented two examples of situations where aspects of the disclosed embodiments are used. As a background for both examples, the user is a member of an art forum online. There is a discussion going on about the renaissance art in the art forum space but the user is not aware of that since the user has not logged in for a while.

### EXAMPLE 1

### Physical Context

The user is visiting a renaissance art exhibition. The exhibition area provides information via WLAN about the theme, event, organizer, artists, etc of the exhibition. The user's mobile terminal receives this information and has also received information on a recently emerged active discussion about renaissance art taking place in the art forum. The mobile terminal makes an analysis of the user's current context as well as the discussion in the art forum (remote context). It notices the similarities between the current context and the remote context. The user's device informs the user about this match and asks the user to share information provided by the exhibition site to the art forum. The user decides to do that but the user wants to add personal touch to the contribution by posting few images of some master pieces.

### EXAMPLE 2

### Logical Context

The user is browsing virtual art galleries on the web in order to find out information on potential exhibitions for the user's water color paintings. Accidentally, the user comes across with a site including a remarkable collection of renaissance art and information of artist of that era. The user's mobile terminal notices the similarity between the current site (current context) and a discussion in the art forum (remote context). The user is just about to continue searching more relevant information for the user's purpose, when the mobile terminal informs the user's about the renaissance related discussion taking place in the art forum. The browser suggests the user to contribute this information to the art forum and the user decides to post the URL with a few examples to the art forum. The user is proud of being such an active contributor when continuing search of potential exhibitions.

While the method for context comparison has been described as being performed in the mobile terminal, it can equally well be performed in the server 122, which is in communication with the mobile terminal. In the case of the method being performed on the server, the step to alert the user 468 involves sending a message from the server to the mobile terminal to alert the user of the mobile terminal.

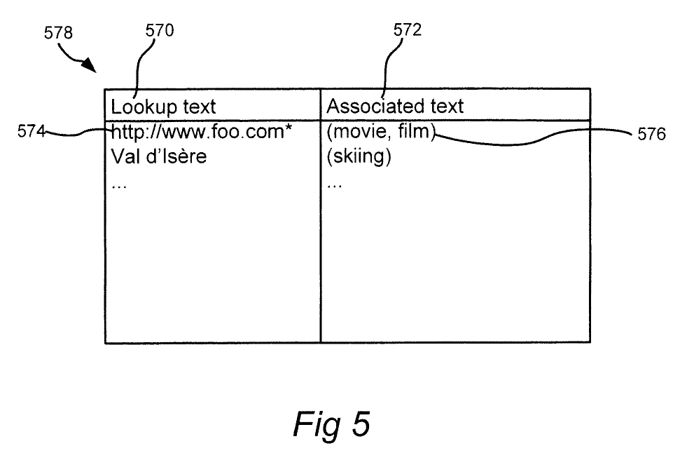

FIG. 5 shows a table 578 that can be used in the process illustrated in FIG. 4. The table 578 is stored may reside in memory of the mobile terminal or an external memory accessed over a network or local connection. The table 578 comprises two columns, a lookup text column 570 and an associated text column 572. The lookup text column 570 can optionally support wildcards. As an example there is a first entry with the lookup text 574 “http://www.foo.com*” and the associated text 576 “(movie film)”. For example, when the look up look up and add associated words step 464 from FIG. 4 above looks up associated words for the text “http://www.foo.com/film=casablanca”, there will be a match with the first entry, and the text “(movie, film)” will be returned.

The invention has mainly been described above with reference to a few embodiments. However, as is readily appreciated by a person skilled in the art, other embodiments than the ones disclosed above are equally possible within the scope of the invention, as defined by the appended patent claims.

1. A method for a portable apparatus comprising:
determining a current context;
determining a remote context;
receiving current data, associated with said current context of said apparatus;
receiving remote data associated with said remote context;
evaluating whether there is a match between said current data and said remote data; and
when said current data and said remote data is considered a match, alerting said user.

2. The method according to claim 1, wherein said remote context previously has been selected by said user.

3. The method according to claim 1, wherein said determining a current context comprises determining a current location of said portable apparatus.

4. The method according to claim 1, wherein said determining a remote context comprises determining an association of said user with any context selected from the group consisting of an online community, a blog, and an online forum.

5. The method according to claim 1, wherein said evaluating whether there is a match comprises statistical text analysis of text of said current data and said remote data.

6. The method according to claim 5, wherein said evaluating whether there is a match comprises, prior to said statistical text analysis:
using at least part of said text of said current data or at least part of said remote data as candidate text;
looking up said candidate text in a table;
when there is a match of said candidate text in said table, reading associated text from said memory, said associated text being associated with said match with said candidate text; and
adding said associated text to said current data or said remote data, according to the source of said candidate data.

7. The method according to claim 1, wherein said receiving current data comprises receiving said current data over a local communication channel.

8. The method according to claim 7, wherein said local communication channel is a channel selected from the group consisting of bluetooth, wireless local area network, radio frequency identification, wireless universal serial bus and any combination of the above.

9. The method according to claim 1, wherein said receiving current data comprises receiving said data based on a position of said apparatus, said position being acquired by use of a global positioning system.

10. The method according to claim 1, wherein said receiving said remote data comprises receiving data using a news feed.

11. The method according to claim 10, wherein said news feed comprises the use of RSS.

12. The method according to claim 1, wherein said method is executed in said portable apparatus.

13. The method according to claim 1, wherein said method is executed in a server.

14. A portable apparatus comprising:
a controller;
said controller being configured to determining a current context;
said controller being further configured to determining a remote context;
said controller being further configured to receive current data, associated with a current context of a user of said apparatus;
said controller being further configured to receive remote data associated with a context previously selected by said user;
said controller being further configured to evaluate whether there is a match between said current data and said remote data; and
said controller being further configured to alert said user when said current data and said remote data is considered a match.

15. A portable apparatus comprising:
means for determining a current context;
means for determining a remote context;
means for receiving current data, associated with a current context of said apparatus;
means for receiving remote data associated with a context previously selected by said user;
means for evaluating whether there is a match between said current data and said remote data; and
means for alerting said user when said current data and said remote data is considered a match.

16. A server comprising:
a controller;
said controller being configured to determine a current context;
said controller being further configured to determining a remote context;
said controller being further configured to receive current data, associated with a current context of a user a portable apparatus connected to said server;
said controller being further configured to receive remote data associated with a context previously selected by said user;
said controller being further configured to evaluate whether there is a match between said current data and said remote data; and
said controller being further configured to alert said user when said current data and said remote data is considered a match.

17. A computer program product comprising software instructions that, when executed in a mobile communication terminal, performs the method according to claim 1.
